(19) United States
(12) Patent Application Publication
(10) Pub. No.: US 2021/0277976 A1
(43) Pub. Date: Sep. 9, 2021

(54) Drive system having an absorber arrangement which is provided therein

(71) Applicant: Schaeffler Technologies AG & Co. KG, Herzogenaurach (DE)

(72) Inventors: Christian Dinger, Achern (DE); Stephan Maienschein, Baden-Baden (DE)

(73) Assignee: Schaeffler Technologies AG & Co. KG, Herzogenaurach (DE)

(21) Appl. No.: 17/261,772

(22) PCT Filed: Jul. 22, 2019
(86) PCT No.: PCT/DE2019/100672

§ 371 Date: Jan. 20, 2021

(30) Foreign Application Priority Data
Aug. 8, 2018 (DE) 10 2018 119 285.1

(51) Int. Cl. F16F 15/14; B60K 17/22

(52) U.S. Cl. CPC F16F 15/145; B60K 17/22; F16F 2232/02; F16F 2226/048; F16F 2226/042; F16F 2222/08

(57) ABSTRACT

A drive arrangement having an internal combustion engine, a transmission device with a power input and a power output, having an electric motor or converter which comprises a rotor, for the output of a drive torque to the power input of the transmission device is provided. An absorber arrangement is provided for rotation about a central axis for the reduction of the degree of irregularity of the rotational drive movement of the internal combustion engine, which rotational drive movement is introduced into the transmission device at the power input thereof. The absorber arrangement comprises a first carrier part, a second carrier part, a plurality of absorber masses which follow one another in the circumferential direction, and a coupling mechanism, for the movement of the absorber masses in a radial plane with respect to the central axis in accordance with a relative rotation of the carrier parts with respect to one another.

### CROSS-REFERENCE TO RELATED APPLICATIONS

This application is the U.S. National Phase of PCT Appln. No. PCT/DE2019/100672 filed Jul. 22, 2019, which claims priority to DE 102018119285.1 filed Aug. 8, 2018, the entire disclosures of which are incorporated by reference herein.

### TECHNICAL FIELD

The disclosure relates to a drive system having an internal combustion engine, a transmission device, and an absorber arrangement which is arranged in a system portion of the drive system that is kinematically located between the internal combustion engine and the transmission device.

In particular, the disclosure relates to a drive system with an integrated absorber arrangement, the absorber frequency of which changes adaptively to the rotational frequency of the absorber arrangement, wherein the absorber arrangement is implemented in a so-called ring pendulum or centrifugal pendulum design and comprises a plurality of absorber mass elements which can be moved in a radial plane with respect to the axis of rotation of the absorber arrangement by being conducted and/or articulated accordingly by means of a track or articulated structure.

### BACKGROUND

A hybrid drive system for a motor vehicle is known from DE 10 2016 217 220 A1, comprising an internal combustion engine, an electric motor, a transmission device, and an absorber arrangement, wherein the absorber arrangement and the electric motor are arranged in an intermediate region between the internal combustion engine and the transmission device. The internal combustion engine and the electric motor are coupled to the input of the transmission device.

### SUMMARY

The object of the disclosure is to provide solutions which make it possible, in a drive system of the type mentioned above, to increase the regularity of the drive torque applied to the power input of the transmission device and to reduce the amplitude of angular velocity fluctuations at the transmission input.

This object is achieved according to embodiments disclosed herein by an absorber arrangement having:

an internal combustion engine,
a transmission device with a power input and a power output,
a converter or an electric motor, comprising a rotor, for the output of a drive torque to the power input of the transmission device, and
an absorber arrangement provided to rotate around a central axis to reduce the degree of irregularity of the rotational drive movement of the internal combustion engine introduced therein at the power input of the transmission device,
wherein the absorber arrangement comprises a first carrier part, a second carrier part, a plurality of absorber masses which follow one another in the circumferential direction, and a coupling mechanism, for movement of the absorber masses in a radial plane with respect to the central axis in accordance with a relative rotation of the carrier parts to one another, and
the drive torque of the rotor is conducted to the transmission input via the coupling mechanism of the absorber arrangement.

This advantageously makes it possible, in a drive system for a motor vehicle, to significantly improve, in a manner that is essentially neutral in terms of weight and space, the absorbance characteristics of the absorber arrangement in relation to the moment of inertia of the rotor. In addition, the rotor can advantageously be integrated into the overall system via the carrier part of the absorber arrangement that carries the rotor, and the connection interface of the absorber arrangement also serves to couple the rotor torque into the transmission input in a synergetic manner.

According to an embodiment, the rotor is attached to the second carrier part. The first carrier part is then attached to the power input of the transmission device. The coupling mechanism then couples the first carrier part, including the absorber masses, to the second carrier part, the inertia of which is increased by the moment of inertia of the rotor. The coupling is achieved by joint and/or guide structures. The maximum rotatability of the carrier parts is preferably limited by the coupling mechanism, wherein there is preferably no hard end position limitation in the coupling mechanism, but rather the restoring forces increase, for example, asymptotically when approaching an end position.

According to embodiments, a ring pendulum system is created by integrating a component of a converter or an electric motor into the absorber arrangement, in which said component of the converter or the electric machine acts as an additional annular mass.

With a ring pendulum system, the centrifugal mass is basically determined by the available installation space and by strength limits, e.g., by the max. surface pressure in guide and joint portions or, in particular in the case of a roller guide, is limited by the pressure in the roller contact. The annular mass of the free carrier part of the absorber arrangement, in relation to a converter or the rotor of an electric motor, is increased in a manner that is neutral in terms of space and total weight.

With embodiments according to the disclosure, it is achieved that, by increasing the annular mass, a likewise increased restoring torque can be generated, with the same or even reduced oscillation angle. Furthermore, due to the increased annular mass with respect to the rotor, the roller conveyors can advantageously be designed to be steeper with the same order.

In an associated, again advantageous, manner, with steeper roller conveyors, the looping or osculation in the roller contact is also increased and the pressures in the roller contact area are thus reduced. This increase in strength now also allows more centrifugal mass to be incorporated into the absorber arrangement, in turn improving the function.

The absorber arrangement according to the disclosure, in particular, when the rotor of an electric motor is used as an additional annular mass, can be constructed such that the rotor surrounds the absorber arrangement and the absorber arrangement is thus located in the interior of the rotor. This rotor can then be coupled to the free end of the absorber arrangement, i.e., the second carrier part, by means of a bell-like or drum-like component. This component carries the rotor on the outside and is axially attached to the second carrier part via a flange portion protruding radially inwardly and attached to the second carrier part. This connection can be achieved in particular by riveting, caulking and/or welding.

Locally complementary joining structures that support the centering of the components and/or support the torsion-proof coupling of these components can be formed on the connecting part provided for connecting the rotor to the second carrier part, or on the rotor or its carrier. The connecting means provided for coupling the two components can in particular be brought into their holding state by way of plastic deformation.

If the rotor is the rotor of an electric motor, it is preferably constructed and arranged such that said rotor surrounds the first carrier part, and preferably also the entire absorber arrangement, on the outside. The rotor and the absorber arrangement can be combined to form an assembly which is attached to the transmission or the internal combustion engine as a corresponding assembly within the course of the assembly of the drive system.

If the rotor is the rotor of a hydrodynamic converter, it is preferably arranged axially closely adjacent to the second carrier part. Here, too, it is possible to combine the absorber arrangement and the converter to form an assembly which as such can be pushed onto the input shaft of the transmission device in one piece.

The coupling mechanism is preferably constructed such that it comprises a spring mechanism, wherein the spring mechanism is then preferably designed such that it generates restoring forces which force the absorber masses into a starting position. The spring mechanism can be designed such that it is effective between the first and the second carrier part and comprises cylindrically wound absorber springs that are aligned in the circumferential direction and therefore also effective in terms of force in the circumferential direction. On the one hand, the spring mechanism has the function of a reset mechanism; it also has the function that its bias increases with increasing angular speed, and the absorber frequency is thereby also increased. An elastic end stop is preferably also implemented via the spring mechanism, limiting the maximum deflection of the ring pendulum segments or the maximum rotation of the first and second carrier parts with respect to one another.

The spring mechanism can also contain spring systems in which compression or arc springs or series or parallel connections of spring systems are provided. Elastomer dampers and friction devices can also be provided in order to limit the relative rotation of the two carrier parts by applying restoring torques and, if necessary, withdrawing energy from the system.

The coupling mechanism is preferably designed such that it causes the centers of gravity of the ring pendulum segments to be shifted along a path with a path component that is radial to the central axis. For this purpose, the coupling mechanism can comprise a curve structure and/or a joint structure. The coupling mechanism is furthermore preferably designed such that a temporary increase in angular speed results in a radially outward movement of the absorber masses and a temporary decrease in angular speed results in a radially inward movement of the absorber masses.

Those ring pendulum segments forming the absorber masses are preferably coupled to the first carrier part or the second carrier part pivotably or moveably along curved paths; corresponding kinematics can also be implemented by means of guide structures.

At least the carrier parts are preferably manufactured as a formed sheet metal part from sheet steel. The ring pendulum segments are preferably manufactured as relatively thick-walled cut, cast, press-formed, or drop forged parts.

It is possible to incorporate structures or subsystems into the ring absorber arrangement according to embodiments, by means of which energy is drawn from the system during the movement of the two carrier parts relative to one another. For this purpose, friction systems or hydrodynamically damping structures can be implemented, effective in particular between the carrier parts and/or the absorber mass segments. In particular, it is possible to combine the absorber arrangement within the rotor to form a sealed unit that is encapsulated and optionally filled with a viscous medium, in particular grease or oil. The sealing can be achieved by elastomeric structures, which are materially attached to the structures that can be moved relative to one another and which compensate for the maximum twisting of the carrier parts by means of their inherent elasticity. A complete seal without running gaps can thus be achieved.

### BRIEF DESCRIPTION OF THE DRAWINGS

Further details and features of embodiments of the disclosure are described in the following description in conjunction with the drawings. In the figures:

FIG. 1 shows a schematic axial half-sectional view, to illustrate the structure of a drive system for a motor vehicle with a rotor of an electric motor, directly laterally in contact with the second carrier part of the absorber arrangement and non-rotationally attached thereto, wherein said rotor axially overlaps the absorber arrangement and a coupling attached to the absorber arrangement;

FIG. 2 shows a schematic representation to further illustrate the functional principle of an absorber arrangement according to embodiments with absorber springs which serve to reset the carrier parts and spring elements which are arranged kinematically parallel thereto and which are used to limit the end positions;

FIG. 3 shows a representation of a replacement model to illustrate a first design of the absorber;

FIG. 4 shows an illustration of a substitute model to illustrate a second design of the absorber (so-called isoradial ring pendulum absorber);

FIG. 5 shows a schematic representation to illustrate the structure of a drive system for a motor vehicle with a converter, directly laterally in contact with the second carrier part of the absorber arrangement and non-rotationally attached thereto;

FIG. 6 shows a schematic representation to illustrate the functional principle of an absorber arrangement according to embodiments with end position dampers;

FIG. 7 shows a schematic representation to illustrate the functional principle of an absorber arrangement according to embodiments with permanent center reset by biased absorber springs and additional end position damping;

FIG. 8 shows a sketch to illustrate a spring pack with an external return spring and an end position spring accommodated therein.

### DETAILED DESCRIPTION

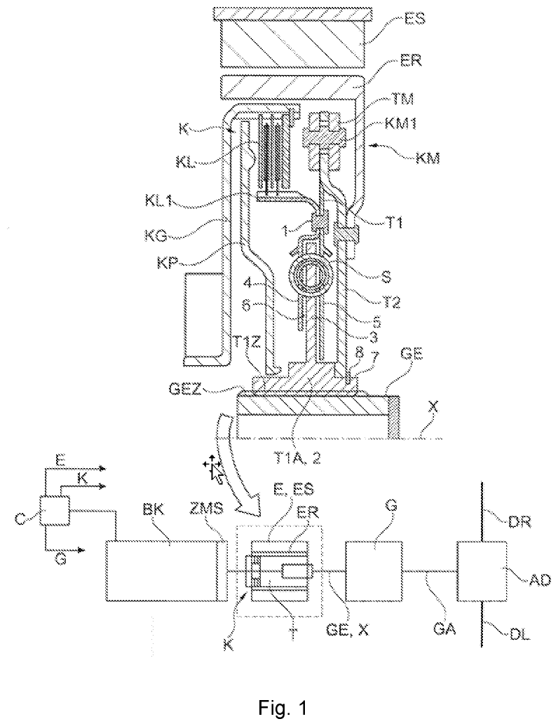

The representation according to FIG. 1 illustrates, in partly schematic form, a drive system in the form of a hybrid drive system for a motor vehicle that comprises an internal combustion engine BK, an electric motor E, a coupling device K, and a transmission device G. The transmission device G is coupled to the internal combustion engine BK while including an absorber arrangement T. The absorber arrangement T here sits in an intermediate area between the internal combustion engine BK and the transmission device G and is coupled to a power input GE of the transmission device G. In addition, the coupling device K and the absorber arrangement T are combined to form an assembly. The hybrid drive system comprises a control device C by means of which the internal combustion engine BK is controlled in accordance with performance requirements. In the arrangement shown here, the control device C also controls the transmission G, the coupling K, and the electric motor E, optionally with incorporation of further electrical and optional electromechanical components (not shown).

The transmission device G also comprises a power output GA. The transmission device G is preferably designed as a manual transmission, as a transmission with a continuously variable transmission ratio, or as a combination transmission with switchable stages and a system portion with continuously variable transmission ratio that is provided, for example, for the lower speed range. The power that can be tapped from the power output GA is branched to wheel drive shafts DL, DR via an axle differential gear AD.

The electric motor E comprises a stator ES and a rotor ER for the output of a drive torque to the power input GE of the transmission device G in accordance with the electrical activation of the electric motor E. The electric motor E functions primarily as a drive motor for the electric motor operation of the vehicle, but it can also be used as a starter for a start/stop operation and can also be operated temporarily as a generator when the vehicle is coasting or also generally to provide or maintain the on-board voltage.

The absorber arrangement T is arranged coaxially to the axis of rotation X of the transmission input shaft GE and serves to reduce the degree of irregularity of the rotational drive movement of the internal combustion engine BK introduced therein at the power input GE of the transmission device T.

The absorber arrangement T comprises a first carrier part T1, a second carrier part T2, a plurality of absorber masses TM which follow one another in the circumferential direction and a coupling mechanism KM for the movement of the absorber masses TM, in particular in a radial plane with respect to the central axis X in accordance with the force systems that result in connection with the relative rotation of the carrier parts T1, T2 relative to each other and the movement of the absorber masses TM.

The drive arrangement according to embodiments disclosed herein is characterized in that the rotor ER of the electric motor E is attached to one of the carrier parts T1, T2, in the present case to the second carrier part T2, the so-called free carrier part of the absorber device, and thus increases its moment of inertia. From a kinematic point of view, the second carrier part T2 is located on the side of the coupling mechanism KM facing away from the transmission input GE and is pivotable with respect to the transmission input GE by moving the absorber masses. The drive torque of the rotor ER is thus coupled into the second carrier part T2 and conducted into the first carrier part T1 via the coupling mechanism KM. It is only by means of this first carrier part T1 that the drive torque of the rotor ER reaches the carrier hub T1A and the transmission input GE. The rotor ER is thus slightly pivotable, via the absorber arrangement, with respect to the transmission input GE in accordance with the coupling mechanism KM. That rotor ER has a portion or a support structure which is in contact with the second carrier part T2 axially, i.e., from the side, and which is attached, in particular riveted, clawed, caulked, and/or welded, to the second carrier part T2.

The rotor ER is integrated into the drive arrangement in such a way that it surrounds the second carrier part T2 and the coupling mechanism KM attached thereto on the outside in the manner of a pot wall and thus accommodates them in its interior.

The first carrier part T1 is attached to the transmission input shaft GE in cooperation with a carrier hub T1A. While the carrier hub T1A engages in a torsion-proof manner into an external tooth system GEZ of the transmission input shaft GE via an internal tooth system T1Z, the first carrier part T1 is still pivotable to a limited extent and is supported, via springs, on the carrier hub T1A in the circumferential direction. The rotatability of the first carrier part T1 with respect to the carrier hub T1A is, however, preferably strictly limited to, for example, +/−8°. The carrier hub T1A comprises a socket portion 2 and a radial flange 3. The inside of the socket portion 2 is provided with the internal tooth system T1Z, the radial flange 3 serves for the connection, pivotable about the axis X of the first carrier part T1 to the carrier hub T1Z.

The first carrier part T1 also carries a coupling plate carrier KL1. It is manufactured as a formed sheet metal part, in particular as a deep-drawn part, and is attached to the first carrier part T1, in particular riveted via rivet 1. The coupling plate carrier KL1 forms a hub portion 4 which, in cooperation with an inner portion 5 of the first carrier part T1, delimits an annular disc space 6 in which the radial flange 3 of the carrier hub T1A sits. On the socket portion 2 of the carrier hub T1A, a seat portion 7 is formed by a circumferential step, on which the second carrier part T2 sits and is conducted in a limited pivotable manner. The second carrier part T2 is secured axially on this seat portion 7, which is achieved here by a spring ring 8 which sits in a circumferential groove of the seat portion 7. The second carrier part T2 is therefore pivotable, at least to a limited extent, about the axis X with respect to the carrier hub

T1A. The transmission of the drive torque, introduced by the rotor ES into the second carrier part T2, into the first carrier part T1 is achieved via the coupling mechanism KM, which in itself serves to create a functional relationship between the rotation of the carrier parts Ti, T2 with respect to one another and the movement of the absorber masses TM so that, each relative position of the carrier parts Ti, T2 with respect to one another results in a defined position of the absorber masses TM with respect to the carrier parts T1, T2.

The coupling mechanism KM couples the first carrier part T1, the absorber masses TM, and the second carrier part T2 such that a relative rotation of the two carrier parts T1, T2 results in a movement of the absorber masses TM relative to one another. The coupling mechanism KM herein is formed with the inclusion of the carrier parts T1, T2 and the absorber masses TM, as well as roller guide pins KM1. The coupling mechanism KM is designed such that the absorber masses TM are articulated on the first carrier part T1 and the respective roller guide pin KM1 either sits on the second carrier part T2 and engages in a curved path that is formed in the absorber mass TM or sits in the respective absorber mass TM and engages in a curved path that is formed in the second carrier part T2. The coupling mechanism KM is designed in particular such that all absorber masses TM, in their respective angular segment, perform the same movements in the radial and, if applicable, in the circumferential direction with respect to the axis of rotation X. The absorber masses TM are thus forcibly synchronized via the coupling mechanism KM. This makes it possible to eliminate excitations caused by gravity at low speeds. The movement characteristic of the absorber masses TM during the relative rotation of the carrier parts T1, T2 with respect to one another is preferably coordinated by the internal combustion engine BK taking into account the absorber arrangement T excitations that are anticipated and to be at least largely compensated. The coupling mechanism KM can be designed such that it provides asymmetrical compensation characteristics for positive overshoots of the angular speed of the transmission input shaft GE and for negative overshoots. For this purpose, the coupling mechanism KM comprise, for example, a curve structure and/or an articulated structure which is designed such that temporary acceleration results in a radially outward movement of the absorber masses TM and a temporary deceleration of the angular velocity results in a radial inward movement of the absorber masses TM, wherein the absorber masses TM are movably, in particular pivotably, coupled to the first carrier part T1 and/or the second carrier part T2.

The coupling mechanism KM further comprises an energy storage device or spring mechanism S, wherein this spring mechanism S is designed such that it generates restoring forces which force the absorber masses TM into a starting position, in particular a central position. The spring mechanism S can be designed such that it takes on a plurality of functions; for example, it can cause a suspension of the first carrier part T1 with respect to the carrier hub TN1, a central positioning of the absorber masses TM, and also an end position limitation, which resiliently causes the rotation of the two carrier parts T1, T2 to be limited with respect to each other. The spring mechanism S can be designed such that it comprises absorber springs S1, S2, which are aligned in the circumferential direction and which are slightly curved around the axis of rotation X, but which are otherwise cylindrically wound.

The absorber arrangement T is preferably matched to a main exciter frequency of the internal combustion engine. The absorber arrangement according to the invention preferably forms a ring pendulum absorber which functions as a speed-adaptive torsional vibration absorber. The increased moment of inertia of this component T2 due to the connection of the rotor ER to the second carrier part T2 according to the invention results in an improved torsional vibration isolation capacity, regardless of installation space and weight.

The absorber masses TM are carried along in the circumferential direction via their mounting on the second carrier part T2 and can be moved in the radial direction to a limited extent. The movement in the radial direction is achieved by a guide mechanism KM1.

The power flow from the rotor ER to the transmission input shaft takes place into the second carrier part T2, from there into the coupling mechanism KM, from the coupling mechanism KM into the first carrier part T1, and from there, with the inclusion of the spring mechanism S and the carrier hub T1A, into the transmission input shaft GE. The rotor ER is thus pivotably coupled to the first carrier part T1, subjected to the disturbance event via the coupling mechanism KM; it is therefore attached to the free end of the absorber arrangement T which is kinematically remote from the transmission input.

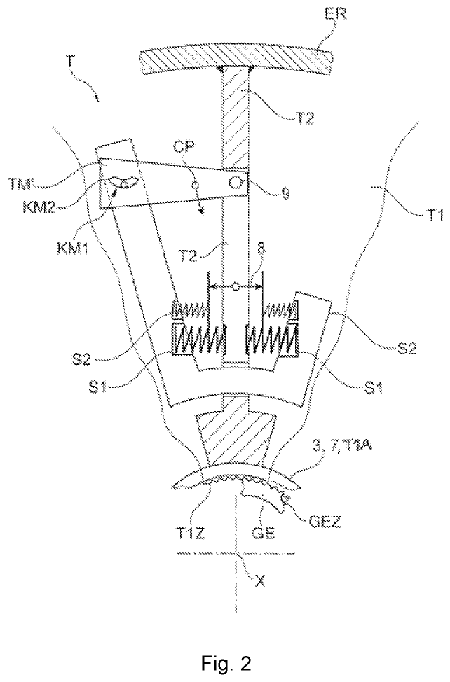

The illustration of FIG. 2 shows its structure by example, schematically, and reduced to an angular segment of the absorber arrangement. To simplify the illustration, the first carrier part T1 herein is coupled non-rotatably directly to the transmission input shaft GE via the toothing T1Z. (In the embodiment according to FIG. 1, the toothing T1Z is formed on the hub part T1A and the first carrier part T1 sits on the hub part T1A with spring support in the circumferential direction.) The first carrier part T1 carries the absorber springs S1 by means of which the first hub part T1 and the second hub part T2 are biased against one another in a central position. The first carrier part T1 also carries the end position springs S2, which become effective when a structurally matched pivoting angle of the two carrier parts T1, T2 is reached and form a resilient end stop that limits the maximum pivoting of the two carrier parts T1, T2 about the axis X. The typical oscillation range of the carrier parts T1, T2 in normal operation with respect to one another lies between the swivel range 8 defined by the end position springs S2.

When the carrier parts T1, T2 are pivoted relative to one another, the absorber mass element TM′ shown here is carried along in the circumferential direction via its articulated connection 9 to the second carrier part T2. The coupling structure kM1 achieves that a movement of the absorber mass element TM′ relative to the first carrier part T1 in the circumferential direction results in the center of gravity CP of the absorber mass element TM′ to also be moved in the radial direction. The characteristics of this mechanical coupling are coordinated, among other things, via the path of the guide track KM2 in the first carrier part T1 or in the absorber mass element TM' . In the absorber arrangement T according to embodiments, a plurality of such units are arranged around the transmission axis X in succession in the circumferential direction. In the practical implementation, the actual structure of the carrier parts Ti, T2 and the absorber mass elements TM' differs from the structure shown here schematically.

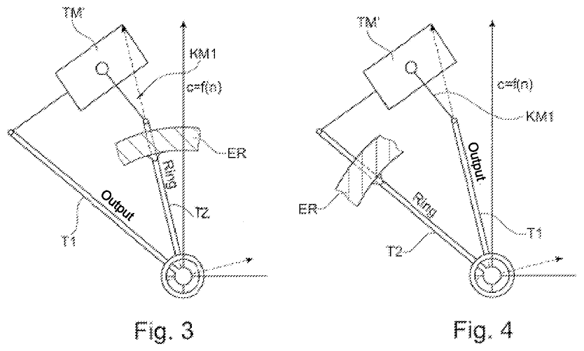

The illustration according to FIG. 3 illustrates the kinematic equivalent model for a design in which the absorber mass element TM' is articulated on the first carrier part T1

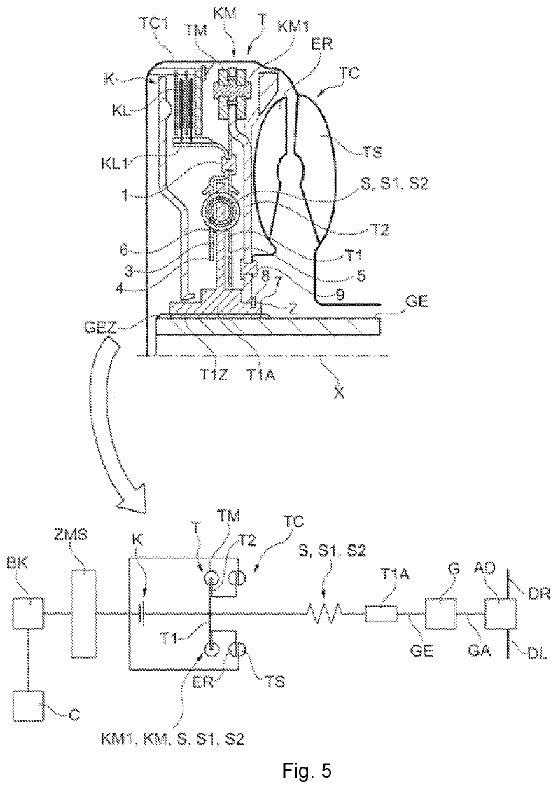

P181025 WO-US and thus on the output. The radial movement of the absorber mass element TM' is achieved by the coupling structure KM1 , which is effective between the second carrier part T2 and the absorber mass element TM'. The moment of inertia of the second carrier part T2 is increased by the connection of the rotor ER of the electric motor E or the converter TC (see FIGS. 1 and 5).

The illustration according to FIG. 4 illustrates the kinematic equivalent model for a design in which the absorber mass element TM' is articulated on the second carrier part T2. The radial movement of the absorber mass element TM' is achieved by the coupling structure KM1 , which is effective between the first carrier part T1 and the absorber mass element TM. The moment of inertia of the second carrier part T2 is here again increased by the connection of the rotor ER of the electric motor E (see FIG. 1) or the converter (see FIG. 5).

Although shown differently in FIGS. 3 and 4, the absorber arrangement according to embodiments is preferably implemented in a design in which the rotor ER surrounds the absorber arrangement T on the outside and is housed therein or axially in contact therewith. The absorber arrangement T achieves the kinematic coupling of the rotor ER to the transmission input shaft via the second carrier part T2, which per se is a free link of the absorber arrangement T. By connecting the rotor ER to the second carrier part T2, its moment of inertia can be significantly increased without increasing the mass of the overall system. By increasing the moment of inertia of the second carrier part T2, the compensation effect of the absorber arrangement T, in particular also with regard to the absorption spectrum, can likewise be increased considerably.

The mode of operation of the drive arrangement according to embodiments is described in detail below in connection with FIGS. 1 to 4:

When the internal combustion engine of a corresponding motor vehicle is operated in a mode of low power demand and at medium speed, a control device C of the internal combustion engine BK causes a cylinder shutdown. Due to the now changed ignition interval and the changed ignition sequence, the regularity of the angular velocity of the crankshaft of the internal combustion engine decreases and a periodic oscillation is superimposed on the rotation of the output of the dual-mass flywheel ZMS. The dual mass flywheel ZMS is couplable to the transmission input shaft GE in a frictionally engaged manner via the coupling device K. If the coupling device K is brought into a coupling state, the drive torque applied to the dual-mass flywheel ZMS is introduced into the hub area 5 of the first carrier part T1 of the absorber arrangement T via the coupling device K and transferred into the hub part T1A via the peripheral springs S, and from there into the transmission input shaft GE. The drive torque applied to the transmission input GE is transmitted to its output GA, and from there to the axle differential AD, in accordance with the switching state of the transmission G. The axle differential AD divides the drive torque symmetrically between the wheel drive shafts DL, DR.

The absorber arrangement T becomes active as a result of the torque fluctuations in the drive torque which are conducted via the coupling device K. The absorber arrangement T is designed for the expected irregularity spectrum of the torque output by the internal combustion engine BK on the dual-mass flywheel ZMS. A corresponding excitation results in the movement of the carrier parts Ti, T2 and the absorber masses TM with respect to one another, with the development of corresponding dynamic force systems. These ultimately provide a reaction torque on the first carrier part T1 which is matched to the excitation by the internal combustion engine and which largely compensates for the excitation. If the motor vehicle is now to be operated by an electric motor, the coupling device K is opened and the electric motor E is controlled accordingly. The uniform drive torque applied to the rotor ER is coupled into the second carrier part T2 and transmitted to the first carrier part Ti via the coupling mechanism KM. As in the aforementioned drive mode, the first carrier part T1 now drives the transmission input GE via the internal combustion engine BK. If the vehicle is operated in coasting mode, power can be recuperated via the electric motor E if necessary; the corresponding torque for driving the rotor ER is then introduced by the first carrier part Ti into the coupling mechanism KM, and from there into the second carrier part T2. The second carrier part T2 then drives the rotor ER in coasting mode.

In the drive arrangement according to embodiments, the absorber device T acts as a link for the kinematic coupling of the rotor ER to the transmission input shaft TI. In addition, the rotor ER of the rotor acts as a annular mass of the second (“free”) carrier part T2 and thus increases its moment of inertia. The rotor ER also forms a structure which serves to connect the absorber arrangement D, and preferably also the coupling device C, to form a preassembled assembly that herein appears largely encapsulated on the outside. This assembly is installed in the drive system by pushing this assembly over the internal tooth system T1Z

P181025 WO-US onto the external tooth system GEZ of the transmission input shaft GE. This assembly process can be carried out reliably and without special attentiveness. It also results in advantages for the maintenance of the drive system since the rotor, the coupling, and the absorber can be removed from the transmission G as an easily manageable assembly as soon as it is disconnected from the internal combustion engine BK. This assembly can be designed as a so-called dry assembly in which, if at all, only greases are provided to lubricate the movement portions. However, it can also be designed in a particularly advantageous manner as an encapsulated, wet assembly in which the absorber arrangement and preferably also the coupling plates are covered by a viscous lubricant filling.

The illustration according to FIG. 5 again shows, in partially schematic form, a drive system for a motor vehicle which comprises an internal combustion engine BK, a hydrodynamic converter TC, a coupling device K, and a transmission device G.

The transmission device T is coupled to the internal combustion engine BK while including an absorber arrangement T. The absorber arrangement T here sits in an intermediate area between the internal combustion engine BK and the transmission device G and is coupled to a power input GE of the transmission device G. In addition, the coupling device K, the absorber arrangement T, and the converter TC are combined to form an assembly. The drive system comprises a control device C by means of which the internal combustion engine BK is controlled herein in accordance with performance requirements. In the arrangement shown here, the control device C also controls the transmission G and the coupling K, optionally with incorporation of further electrical and optional electromechanical components, not shown.

The transmission device G also comprises a power output GA. The transmission device G is preferably designed as a manual transmission, as a transmission with a continuously variable transmission ratio, or as a combination transmission with switchable stages and a system portion with continuously variable transmission ratio that is provided, for example, for the lower speed range. The power that can be tapped from the power output GA is branched to wheel drive shafts DL, DR via an axle differential gear AD.

The converter TC comprises a pump wheel TS and a rotor ER, which forms the turbine wheel of the converter TC, for the output of a drive torque to the power input GE of the

P181025 WO-US transmission device G according to the relative speed between the pump wheel TS and the rotor ES. The converter TC serves to transmit a starting torque; it is arranged kinematically parallel to the coupling K and is bridged by engaging coupling K when a certain operating state is reached.

The absorber arrangement T is arranged coaxially to the axis of rotation X of the transmission input shaft GE and serves to reduce the degree of irregularity of the rotational drive movement of the internal combustion engine BK introduced therein at the power input GE of the transmission device T.

The absorber arrangement T comprises a first carrier part T1, a second carrier part T2, a plurality of absorber masses TM which follow one another in the circumferential direction and a coupling mechanism KM for the movement of the absorber masses TM, in particular in a radial plane with respect to the central axis X in accordance with the force systems that result in connection with the relative rotation of the carrier parts Ti, T2 relative to each other and the movement of the absorber masses TM.

The drive arrangement according to embodiments is characterized in that the rotor ER of the converter TC is attached to the second carrier part T2, the so-called free carrier part of the absorber device T, and thus increases its moment of inertia. From a kinematic point of view, the second carrier part T2 is located on the side of the coupling mechanism KM facing away from the transmission input GE and is pivotable with respect to the transmission input GE by displacing the absorber masses TM. The drive torque of the rotor ER is thus coupled into the second carrier part T2 and conducted into the first carrier part Ti via the coupling mechanism KM. It is only by means of this first carrier part T1 that the drive torque of the rotor ER reaches the carrier hub T1A and the transmission input GE. The rotor ER of the converter TC is thus slightly pivotable, via the absorber arrangement T, with respect to the transmission input GE in accordance with the coupling mechanism KM. That rotor ER has a portion or a support structure which is in contact with the second carrier part T2 axially, i.e., from the side, and which is attached, in particular riveted, clawed, caulked, and/or welded, to the second carrier part T2 by rivet 9.

The rotor ER is attached to the side of the second carrier part T2 and the impeller TS and a pot structure TC1 supporting it encompass the coupling K and the absorber arrangement T on the outside and hold the enclosed components together to form an assembly.

The first carrier part T1 is attached to the transmission input shaft GE in cooperation with a carrier hub T1A. While the carrier hub T1A engages in a torsion-proof manner into an external tooth system GEZ via an internal tooth system T1Z, the first carrier part T1 is still pivotable to a limited extent and is supported, via springs, on the carrier hub T1A in the circumferential direction. The rotatability of the first carrier part T1 with respect to the carrier hub T1A is again preferably strictly limited to, for example, +/−8°. The carrier hub T1A comprises a socket portion 2 and a radial flange 3. The socket portion 2 is provided with internal teeth T1Z on the inside.

The first carrier part T1 also carries a coupling plate carrier KL1. It is manufactured as a formed sheet metal part, in particular as a deep-drawn part, and is attached to the first carrier part Ti, in particular riveted via rivet 1. The coupling plate carrier KL1 forms a hub portion 4 which, in cooperation with an inner portion 5 of the first carrier part Ti, delimits an annular disc space 6 in which the radial flange 3 of the carrier hub T1A sits. On the socket portion 2 of the carrier hub T1A, a seat portion 7 is formed by a circumferential step, on which the second carrier part T2 sits and is conducted in a limited pivotable manner. The second carrier part T2 is secured axially on this seat portion 7, which is achieved here by a spring ring 8 which sits in a circumferential groove of the seat portion 7.

The coupling mechanism KM couples the first carrier part T1, the absorber masses TM, and the second carrier part T2 such that a relative rotation of the two carrier parts T1, T2 results in a movement of the absorber masses TM relative to one another. The coupling mechanism TM herein is formed with the inclusion of the carrier parts T1, T2 and the absorber masses TM, as well as roller guide pins KM1. The coupling mechanism KM is designed such that the absorber masses TM are articulated on the first carrier part T1 and the respective roller guide pin KM1 either sits on the second carrier part T2 and engages in a curved path that is formed in the absorber mass TM or sits in the respective absorber mass TM and engages in a curved path that is formed in the second carrier part T2. The coupling mechanism TM is designed in particular such that all absorber masses TM, in their respective angular segment, perform the same movements in the radial and, if applicable, in the circumferential direction with respect to the axis of rotation X. The absorber masses TM are thus forcibly synchronized via the coupling mechanism KM. This makes it possible to eliminate excitations caused by gravity at low speeds. The movement characteristic of the absorber masses TM during the relative rotation of the carrier parts Ti, T2 with respect to one another is preferably coordinated by the internal combustion engine BK taking into account the absorber arrangement T excitations that are anticipated and to be at least largely compensated. The coupling mechanism KM can be designed such that it provides asymmetrical compensation characteristics for positive overshoots of the angular speed of the transmission input shaft GE and for negative overshoots. For this purpose, the coupling mechanism KM comprise, for example, a curve structure and/or an articulated structure which is designed such that temporary acceleration results in a radially outward movement of the absorber masses TM and a temporary deceleration of the angular velocity results in a radial inward movement of the absorber masses TM, wherein the absorber masses TM are movably, in particular pivotably, coupled to the first carrier part T1 and/or the second carrier part T2.

The coupling mechanism KM further comprises a spring mechanism S, wherein this spring mechanism S is designed such that it generates restoring forces which force the absorber masses TM into a starting position, in particular a central position. The spring mechanism S can be designed such that it takes on a plurality of functions; for example, it can cause a suspension of the first carrier part T1 with respect to the carrier hub T1A, a central positioning of the absorber masses TM, and also an end position limitation, which resiliently causes the rotation of the two carrier parts T1, T2 to be limited with respect to each other. The spring mechanism S can be designed such that it comprises absorber springs S1, S2 , which are aligned in the circumferential direction and which are slightly curved around the axis of rotation X, but which are otherwise cylindrically wound.

The absorber arrangement T is preferably matched to a main exciter frequency of the internal combustion engine BK. The absorber arrangement according to the invention preferably forms a ring pendulum absorber which functions as a speed-adaptive torsional vibration absorber. The increased moment of inertia of this component T2 due to the connection of the rotor ER of the converter TC to the second carrier part T2 according to the invention results in an improved torsional vibration isolation capacity, regardless of installation space and weight. The absorber masses TM are carried along in the circumferential direction via their mounting on the second carrier part T2 and can be moved in the radial direction to a limited extent. The movement in the radial direction is achieved by a guide mechanism KM1.

The drive torque applied to the rotor ER of the converter TC is coupled into the absorber arrangement T via the “free” carrier part, which is pivotable to a limited extent relative to the transmission input shaft TI, and only reaches the first carrier part T1 via the coupling mechanism KM. The second carrier part T2 thus forms the input interface of the drive arrangement for the torque present on the rotor ES, i.e., on the turbine wheel of the converter TC.

The spring device S provided here both in the upper illustration of the internal structure of the absorber arrangement and in the lower abstracted illustration has a multiple function here, as already mentioned; it forms part of the reset mechanism of the absorber arrangement T and also part of a further spring mechanism for the torque-flexible coupling of the hub part T1A with the first carrier part T1. For this reason, it is shown at two different system locations in the abstracted illustration.

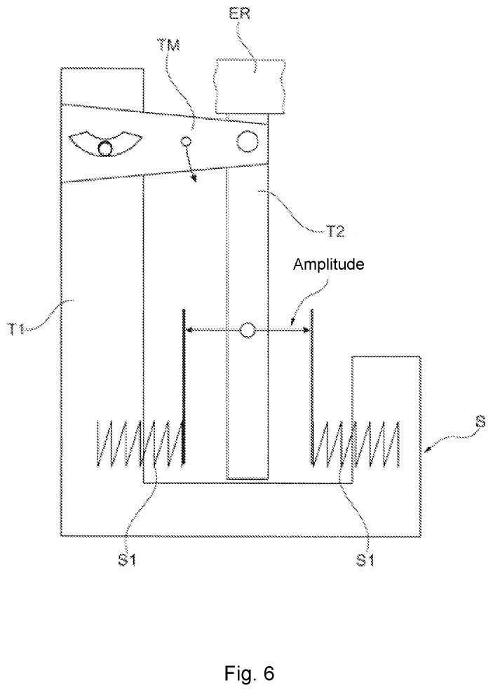

The illustration according to FIG. 6 shows, in a simplified manner, a portion of an absorber arrangement according to the invention to illustrate the free amplitude of the system in combustion operation with the coupling closed. This free amplitude of the second carrier part T2 with respect to the first carrier part T1 is overcome when a drive torque is applied to the rotor ER, i.e., when driven by an electric machine or driven by the converter. In order to prevent the components that are movable relative to the first carrier part T1, in particular the second carrier part T2, with the rotor ES attached thereto, as well as the absorber masses TM, from working against the output produced by the first carrier part T1, the end positions of the two carrier parts T1, T2 are damped with respect to each other by means of energy storage devices S and/or dampers. The centrifugal mass of the absorber masses TM also helps to intercept the accelerated annular mass of the second carrier part and the rotor ER coupled thereto with respect to the output, i.e., the first carrier part Ti, as the speed increases. As the speed increases, the absorber mass TM, which forms a centrifugal mass, generates a counter-torque, which further protects the system from hitting the end positions during operation of the electric machine or converter. The end position damping can, as shown here by way of example, be achieved in particular via compression springs S2 or also via arc springs, series connections of spring systems, parallel connections of spring systems, elastomer dampers and/or friction systems, i.e., friction devices with corresponding, preferably progressive, characteristics.

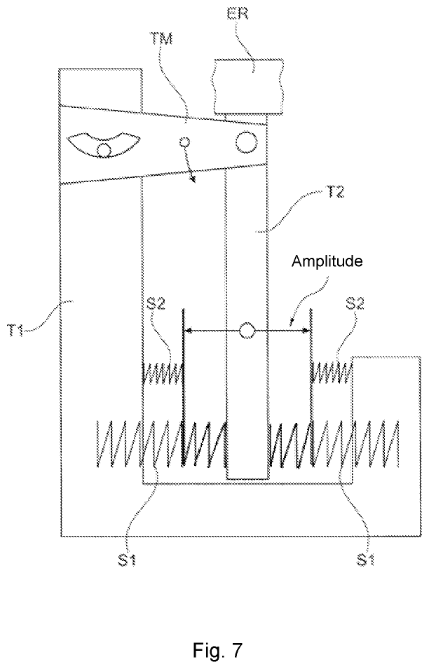

The illustration according to FIG. 7 shows schematically the structure of a further absorber arrangement in which the second carrier part T2 is forced into a central position relative to the first carrier part T1 via an energy storage device S designed here as a spring device S1. The free amplitude is explained here in the same way as with reference to FIG. 6, limited by end position damping which, as shown, can be implemented in particular by spring elements S2 or other energy storage devices.

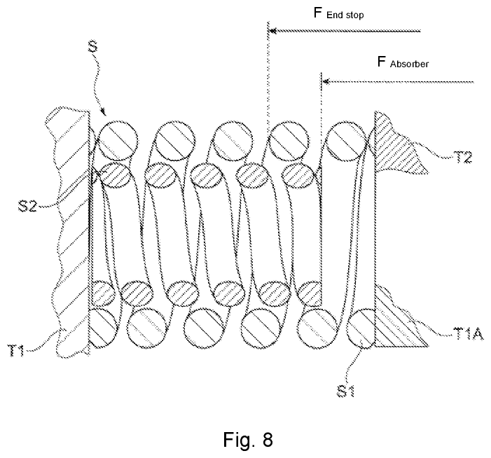

As can be seen from the illustration according to FIG. 8, it is possible to nest the spring element S2 provided for end position damping and the spring element Si provided for return and central positioning. The relatively stiff spring element S2 provided for end position damping then sits in the inner area of the first, somewhat softer spring element S1. When the two carrier parts T1, T2 are moved with respect to one another into an end position, both spring elements S1, S2 contribute to the end position damping as parallel energy storage devices. The spring device shown here can take on an additional function by also using it for the elastic coupling of the first carrier part T1 to the transmission shaft GE. For this purpose, the illustrated spring device can then resiliently support the first carrier part T1 on the absorber hub part T1A in the circumferential direction.

The absorber arrangement according to the invention is preferably implemented my manufacturing the two carrier parts T1, T2 as axially profiled sheet metal parts. In particular, the pockets and holding geometries provided for receiving the energy storage devices, for example the springs, can be formed on these shaped sheet metal parts. Furthermore, structures of the coupling mechanism KM are preferably also implemented by the two carrier parts T1, T2 in interaction with the absorber masses TM.

### LIST OF REFERENCE NUMBERS

1 Rivet

2 Socket portion

3 Radial flange

4 Hub portion

5 Interior portion

6 Annular disc space

7 Seat portion

8 Spring ring

AD Axle differential gear

BK Internal combustion engine

C Control device

DL Wheel drive shaft

DR Wheel drive shaft

E Electric motor

ES Stator

ER Rotor

G Transmission device

GA Power output

GE Power input

GEZ External tooth system

K Coupling device

KM Coupling mechanism

KM1 Coupling structure

KM1 Roller guide pin

T Absorber arrangement

TC Converter

TC1 Pot structure

TM Absorber masses

TM′ Absorber mass element

T1 Carrier part

T1A Carrier hub

T1Z Internal tooth system

T2 Carrier part

S Energy storage device or spring mechanism

S1 Absorber spring

S2 Absorber or end position spring

X Axis

ZMS Dual-mass flywheel

1. An absorber arrangement comprising:
a first carrier part t a central axis and coupled to a transmission input shaft,
a plurality of absorber masses distributed over circumferential angular segments of the first carrier part and configured to be movable radially in a centrifugal force field of the first carrier part, rotatable about the central,
a second carrier part, rotatable to a limited extent with respect to the first carrier part-4²44), and
a coupling mechanism for coupling the first carrier part, the absorber masses, and the second carrier part such that the absorber masses move radially during a relative rotation of the carrier parts about the central axis,
wherein the second carrier part forms a carrier structure to which a rotor serving to introduce a torque is attached and the torque applied to the rotor is conducted into the first carrier part via the coupling mechanism.

2. The absorber arrangement according to claim 1, wherein the rotor has a portion which is axially in contact with the second carrier part and is attached to the second carrier part.

3. The absorber arrangement according to claim 2, the rotor forms part of an electric motor.

4. The absorber arrangement according to claim 3, wherein the rotor surrounds the second carrier part and the coupling mechanism attached thereto on an outside.

5. The absorber arrangement according to claim 1, wherein the rotor forms a turbine wheel of a converter.

6. The absorber arrangement according to claim 5, wherein the rotor is axially laterally in contact with the second carrier part.

7. The absorber arrangement according to claim 1, wherein the first carrier part is, to couple an absorber device to the transmission input shaft.

8. The absorber arrangement according to claim 1, wherein the coupling mechanism comprises an energy storage mechanism and the energy storage mechanism is configured to generate restoring forces which force the absorber masses into a starting position.

9. The absorber arrangement according to claim 8, wherein the energy storage mechanism comprises a spring mechanism.

10. The absorber arrangement according to claim 8, wherein the coupling mechanism comprises a curve structure or an articulated structure and the coupling mechanism is designed such that a temporary increase in torque results in a radially outward movement of the absorber masses and a temporary reduction in torque results in a radially inward movement of the absorber masses, wherein the absorber masses are pivotably coupled to the first carrier part or the second carrier part.

11. The absorber arrangement according to claim 2, wherein the portion of the rotor is attached to the second carrier part by riveting, caulking or welding.
